(19) United States
(12) Patent Application Publication
(10) Pub. No.: US 2012/0041714 A1
(43) Pub. Date: Feb. 16, 2012

(54) SEMICONDUCTOR HEAT TREATMENT MEMBER HAVING SIC FILM

(75) Inventors: Masanori Kawaguchi, Tokyo (JP); Yoichi Kamisuki, Tokyo (JP); Yasuji Fukasawa, Tokyo (JP)

(73) Assignee: Asahi Glass Company, Limited

(21) Appl. No.: 13/281,680

(22) Filed: Oct. 26, 2011

Related U.S. Application Data
(63) Continuation of application No. PCT/JP2010/056712, filed on Apr. 14, 2010.

(30) Foreign Application Priority Data
Apr. 27, 2009 (JP) 2009-107932

(51) Int. Cl. G01B 11/24; B32B 3/00

(52) U.S. Cl. 702/167; 428/141

(57) ABSTRACT

A semiconductor heat treatment member having a CVD-SiC film, which can reduce the frequency of cleaning steps and significantly improves the throughput of wafer process, is provided.

A semiconductor heat treatment member is provided, which has a characteristic that when a Fourier amplitude spectrum of a cross-sectional profile of the CVD-SiC film deposited on the semiconductor heat treatment member obtained by observing the CVD-SiC film by a laser microscope with a magnification of from 400 to 600×, is integrated in ranges of 0.01≦ω≦0.02 and 0.05≦ω≦0.2, to obtain integral values of I1 and I2, respectively, then, I1 is at least 0.9 and 12 is at least 1.6.

### TECHNICAL FIELD

The present invention relates to a semiconductor heat treatment member having a SiC film to be used for a low pressure chemical vapor deposition (hereinafter referred to as LPCVD) step in a semiconductor manufacturing process.

### BACKGROUND ART

A polysilicon film or a silicon nitride film to be deposited on a silicon wafer in a LPCVD step in a semiconductor manufacturing process is not only deposited on the silicon wafer but also deposited on a wafer-supporting jig or on a furnace core tube of a reactor furnace to form the same type of film (hereinafter referred to as deposit film).

By repeating film-deposition steps, the thickness of such a deposit film increases according to the number of film-deposition steps, and when the thickness exceeds a predetermined thickness, formation of cracks in the deposit film or peeling of the deposit film occurs. Accordingly, particles of polysilicon or silicon nitride are generated to form defects of a silicon wafer. Particularly, in a silicon nitride film, since internal stress is formed during the film-deposition, the cracks or peeling occurs even when the film is relatively thin, and the particles tend to be generated.

In order to prevent wafer defects due to particles, in an actual LPCVD step in a semiconductor manufacturing process, when the thickness of a deposit film becomes a predetermined thickness, a cleaning step for removing the deposit film by using a chemical such as hydrofluoric acid or a mixed solution of nitric acid and hydrofluoric acid or a gas such as carbon tetrafluoride or carbon trichloride fluoride, becomes necessary.

Presently, along with miniaturization of semiconductors, the size and the number of particle defects are required to be small and few. For this reason, the tolerable deposition thickness of the deposit film is becoming small and the frequency of the above cleaning step is being increased. However, the increase of the frequency of the cleaning step not only increases the cleaning cost but also significantly reduces the throughput of the wafer process, which causes increase of semiconductor production cost. Particularly, a silicon nitride film generating particles even when the film is relatively thin causes a serious problem.

Heretofore, in order to reduce the cleaning steps, a technique of devising a surface state of a heat treatment semiconductor member to attempt stabilization of the deposit film is proposed. For example, Patent Document 1 discloses that in a SiC heat treatment member coated with a CVD-SiC coating film, by making the average roughness (Ra) of a surface of the SiC coating film deposited by CVD to be 1.5 to 5 μm and making the maximum average surface roughness (Ry) to be 20 to 100 μm, the adhesiveness of a deposit film of polysilicon or silicon nitride improves, and even if such a deposit film is deposited to have a large thickness, no peeling occurs.

Further, Patent Document 2 discloses that also in a CVD-SiC-coated semiconductor member, the deposit film becomes hardly peeled when the surface of the member is grounded so that, in a surface roughness curve obtained by carrying out a swell collection to a result of surface roughness measurement by a surface roughness meter, maximum height of the projections from the average line is at most 3 μm and that the depth of the valley portion from the average line is within a range of from 0.1 to 10 μm. In these prior arts, as described above, by controlling the surface roughness of the SiC-CVD of the semiconductor heat treatment member, that is the height difference of the surface projections, improvement of adhesiveness of the deposit film is attempted.

### PRIOR ART DOCUMENTS

### Patent Documents

Patent Document 1: JP-A-2000-327459

Patent Document 2: JP-A-2001-284275

### DISCLOSURE OF INVENTION

### Technical Problem

As described above, a polysilicon film or a silicon nitride film to be deposited on a silicon wafer in an LPCVD step in a semiconductor manufacturing process, is not only deposited on the silicon wafer but also deposited on a wafer-supporting jig or a furnace core tube of a reactor furnace, to form a deposit film. Along with miniaturization of semiconductors, the tolerable thickness of the deposit film becomes small, whereby the frequency of cleaning step increases to significantly reduce the throughput of a wafer production process.

It is an object of the present invention to provide a semiconductor heat treatment member having a CVD-SiC coating film which can reduce the frequency of cleaning step and which significantly improves the throughput of the wafer manufacturing process; and an evaluation method of a SiC coating film for such a semiconductor heat treatment member.

### Solution to Problem

The present invention has the following constructions.
1. A semiconductor heat treatment member having a CVD-SiC coating film, wherein an average I1 and an average I2 of the CVD-SiC coating film obtained according to the following steps (1) to (6) satisfy the following (A) or (B):

(A) the average I1 is at most 0.9 and the average I2 is at least 1.6;

(B) the average I1 is at least 0.9;

(1) a surface of the CVD-SiC coating film is observed by a laser microscope with a magnification of from 400 to 600×;

(2) from the observation of the CVD-SiC coating film by the laser microscope, cross-sectional profile is measured at each of at least 5 points at intervals of at least 10 μm and 50 μm in terms of the intervals between the cross sections;

(3) Fourier conversion of each of the measured cross-sectional profile is carried

Out;

(4) a Fourier amplitude spectrum is calculated from the Fourier conversion data;

(5) definite integration of the Fourier amplitude spectrum is carried out with respect to a frequency (ω) in an integration range of 0.01≦ω≦0.02 for I1 and an integration range of 0.05≦ω≦0.2 for I2 to obtain I1 and I2; and

(6) I1s and I2s obtained from the cross sectional profiles measured at at least 5 points along X direction are each averaged to obtain an average I1 and an average I2 of the CVD-SiC coating film.
2. The semiconductor heat treatment member according to the above 1, wherein the average I1 is at most 0.4 and the average I2 is at least 1.6.
3. The semiconductor heat treatment member according to the above 1, wherein the average I2 is at least 3 and a ratio between an average I3 and the average I1 (average I3/average I1) is at most 0.6 where the average I3 is obtained by averaging I3s obtained by carrying out a definite integration of the respective Fourier amplitude spectrums obtained from the cross-sectional profiles measured at at least 5 points at intervals of at least 10 μm and at most 50 μm, in an integration range of 0.4≦ω≦0.8.
4. An evaluation method of a SiC film for a semiconductor heat treated member having a CVD-SiC coating film, which comprises expressing the surface state of the CVD-SiC coating film by using an average I1 and an average I2 obtained according to the following steps (1) to (6):

(1) a surface of the CVD-SiC coating film is observed by a laser microscope with a magnification of from 400 to 600×;

(2) from the observation of the CVD-SiC coating film by the laser microscope, cross-sectional profile is measured at each of at least 5 points at intervals of at least 10 μm and 50 μm in terms of the intervals between the cross sections;

(3) Fourier conversion of each of the measured cross-sectional profile is carried out;

(4) a Fourier amplitude spectrum is calculated from the Fourier conversion data;

(5) definite integration of the Fourier amplitude spectrum is carried out with respect to a frequency (ω) in an integration range of 0.01≦ω≦0.02 for I1 and an integration range of 0.05≦ω≦0.2 for I2 to obtain I1 and I2; and
(6) I1s and I2s obtained from the cross sectional profiles measured at at least 5 points along X direction are each averaged to obtain an average I1 and an average I2 of the CVD-SiC coating film.
5. An evaluation method of SiC film for a semiconductor heat treatment member having a CVD-SiC coating film, which comprises expressing the surface state of the CVD-SiC coating film by employing the average I1, the average I2 and the average I3 obtained according to the following steps (1) to (8):

(1) a surface of the CVD-SiC coating film is observed by a laser microscope with a magnification of from 400 to 600×;

(2) from the observation of the CVD-SiC coating film by the laser microscope, a cross-sectional profile is measured at each of at least 5 points at intervals of at least 10 μm and 50 μm in terms of the intervals between the cross sections;

(3) Fourier conversion of each of the measured cross-sectional profile is carried out;

(4) a Fourier amplitude spectrum is calculated from the Fourier conversion data;

(5) definite integrations of the Fourier amplitude spectrum are carried out with respect to a frequency (ω) in an integration range of 0.01≦ω≦0.02 for I1 and an integration range of 0.05≦ω≦0.2 for I2 to obtain I1 and I2;

(6) I1s and I2s obtained from the cross sectional profiles measured at at least 5 points along X direction are each averaged to obtain an average I1 and an average I2 of the CVD-SiC coating film;

(7) a definite integration of each of the Fourier amplitude spectrums is carried out with respect to the frequency (ω) in an integration range of 0.4≦ω≦0.8 for I3 to obtain I3; and

(8) I3s obtained from cross-sectional profiles measured at at least 5 points in X direction are averaged to obtain an average I3 of the CVD-SiC coating film.

### Advantageious Effects of Invention

Heretofore, along with miniaturization of semiconductors, the tolerable deposit thickness of the deposit film becomes thin, and the frequency of cleaning steps has been increased to significantly decrease the throughput of wafer process. However, by employing the semiconductor heat treatment member having a CVD-SiC coating film and the evaluation method of CVD-SiC coating film of the present invention, it is possible to reduce the frequency of cleaning steps and to significantly improve the throughput of wafer process.

### BRIEF DESCRIPTION OF DRAWINGS

FIG. 1(a) is an image photograph of a surface state of a CVD-SiC coating film constituted by large dome-shaped particles observed by a laser microscope.

FIG. 1(b) is a three-dimensional image of the above.

FIG. 1(c) is a view showing an example of a cross-sectional profile of the above.

FIG. 2(a) is an image photograph of a surface state of a CVD-SiC coating film constituted by large pyramid-shaped particles observed by a laser microscope.

FIG. 2(b) is a three-dimensional image of the above.

FIG. 2(c) is a view showing an example of a cross-sectional profile of the above.

FIG. 3(a) is an image photograph of a surface state of a CVD-SiC coating film having a flat smooth shape constituted by extremely small SiC particles observed by a laser microscope.

FIG. 3(b) is a three-dimensional image of the above.

FIG. 3(c) is a view showing an example of a cross-sectional profile of the above.

FIG. 4 is a view showing a Fourier amplitude spectrum of the cross-sectional profile of FIG. 1(c).

FIG. 5 is a view showing a crack densities of silicon nitride films when the silicon nitride films have a thickness of 6 μm and are deposited on SiC substrates coated with CVD-SiC coating films having a thickness of about 60 μm and having various textures formed by controlling the film-deposition conditions.

FIG. 6(a) is an image photograph of a SiC-CVD texture wherein the number of cracks in the silicon nitride film is the smallest.

FIG. 6(b) is a three-dimensional image photograph of the above.

FIG. 6(c) is a view showing an example of a cross-sectional profile of the above.

FIG. 7(a) is a graph showing the densities of cracks due to peeling of a silicon nitride film and cracks due to brittle fracture by internal stress and the sum of them when the silicon nitride film has a thickness of about 1 μm to about 6 μm and is deposited on a SiC substrate having a CVD-SiC coating film having a thickness of about 60 μm and having various textures formed by controlling the film-deposition conditions.

FIG. 7(b) is a graph when a silicon nitride film is deposited on a substrate having a texture different from that of the above graph.

FIG. 8 is a graph showing the densities of cracks due to peeling of a silicon nitride films where the texture is represented by I2, when the silicon nitride films have a thickness of about 4 μm or about 6 μm and are deposited on SiC substrates having deposition films of CVD-SiC having a thickness of about 60 μm having various textures formed by controlling the film-deposition conditions.

FIG. 9 is a graph showing the crack density of cracks due to brittle fracture by internal stress of the silicon nitride film deposited above, where the texture is represented by I3/I1.

FIG. 10 is a view relatively showing the crack densities of a silicon nitride films when the silicon nitride films have a thickness of about 6 μm and are deposited on SiC substrates coated with CVD-SiC deposition films having a thickness of about 60 μm having various textures formed by controlling the film-deposition conditions.

FIG. 11(a) is an image photograph of a SiC-CVD texture whereby the number of cracks in the silicon nitride film is the smallest in FIG. 10.

FIG. 11(b) is a three-dimensional image photograph of the above.

FIG. 11(c) is a view showing an example of a cross-sectional profile of the above.

### DESCRIPTION OF EMBODIMENTS

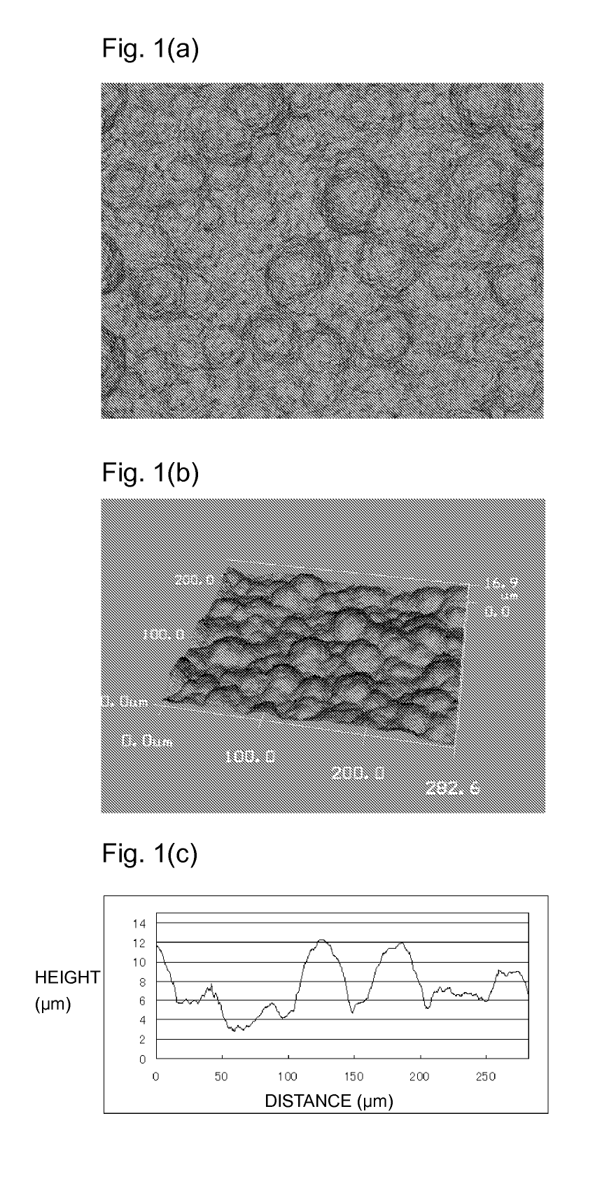

In a SiC coating film deposited on a semiconductor heat treatment member by a CVD method, the shape and the size of SiC particles constituting the SiC film is various depending on the film-deposition conditions as shown in FIGS. 1 to 3. FIGS. 1 to 3 show surface states of surface portions of typical CVD-SiC films observed by a laser microscope. Views of (a) of respective views are images by laser microscope observation, and views of (b) represent three-dimensional images by the laser microscope observation, and the views of (c) are each an example of cross-sectional profile of a part of the view of (a) along a horizontal direction.

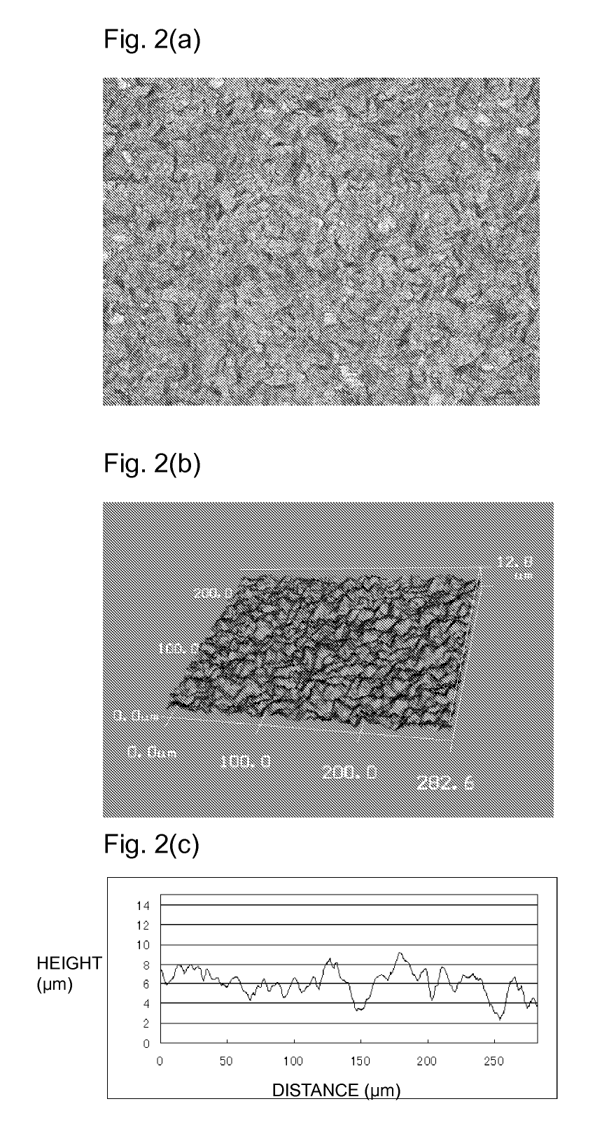

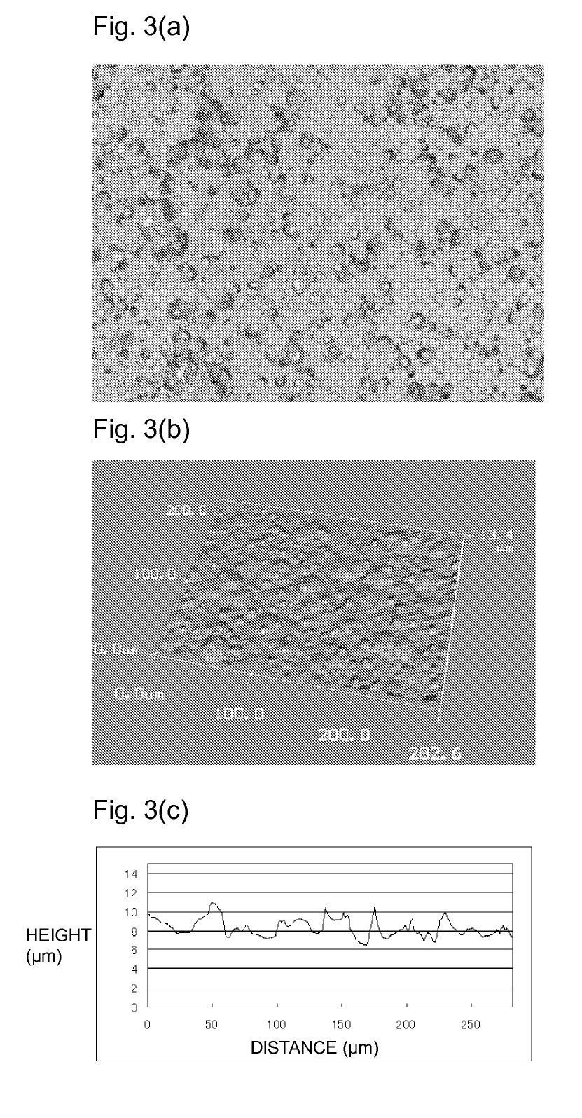

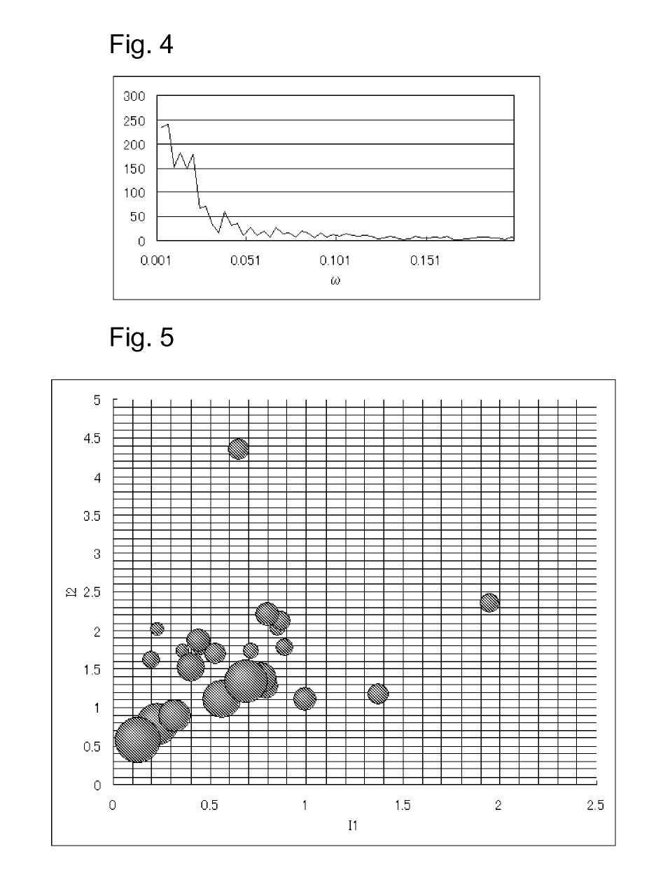

FIG. 1 is a CVD-SiC coating film mainly constituted by dome-shaped relatively large SiC particles, FIG. 2 shows a coating film mainly constituted by relatively large pyramid-shaped SiC particles, and FIG. 3 shows a laser microscope photograph of a smooth coating film constituted by extremely small SiC particles. In an actual CVD-SiC coating film, they are complexly combined and the size of the particles are various, and e.g. a coating film wherein pyramid-shaped particles are formed on dome-shaped particles is present.

According to the research of the inventors, easiness of cracking or peeling a deposit film cannot be uniformly determined by a surface roughness of a CVD-SiC coating film as before, and it has been understood that they are deeply depending on the surface state (hereinafter referred to as texture) of the CVD-SiC coating film.

Under the circumstances, in order to explain the above matter, explanation is made with reference to Table 1 wherein easiness of cracking or peeling of a deposit film is calculated by a simplified shape model. Table 1 uses models wherein a SiC film having a thickness of 3 μm is deposited on a CVD-SiC coating film having a texture wherein the entire surface is constituted by dome-shaped particles alone or pyramid-shaped particles alone, and shows the maximum stress in the silicon nitride film under a specific condition.

More specifically, Table 1 shows simulation results of a stress formed on an interface between a SiC film and a silicon nitride film when the silicon nitride film has a thickness of 3 μm and is deposited by CVD on a member having a CVD-SiC coating film constituted by the same particles having a simple dome shape or a pyramid shape having a bottom side length of L and a height of H on a SiC substrate.

In each of examples (a) to (c) in Table 1, both of the surface roughnesses Rₐ and R_{y} are 4 μm. However, according to the difference in the representing length L or the shape of the particles, the maximum stress is different among these examples. When the maximum stress is large, the silicon nitride film is easily peeled from a CVD-SiC coating film, and easiness of peeling of the silicon nitride film changes among the examples (a) to (c) of Table 1. Further, with respect to a stress for destroying a deposit film to form cracks, easiness of generation of cracks changes according to the difference in the representing length L or the shape of the particles.

Thus, easiness of peeling of the deposit film or generation of cracks is significantly influenced by the shape or the size of particles constituting the CVD-SiC coating film. Accordingly, in order to evaluate the stability of the deposit film, a means for newly defining the texture of the CVD-SiC coating film other than the surface roughnesses Rₐ and R_{y} becomes necessary.

TABLE 1

| | Example a | Example b | Example c |
|---|---|---|---|
| Texture | 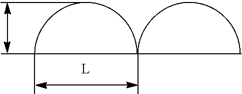 | 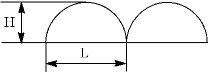 | 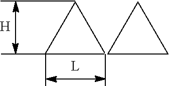 |
| L μm | 5 | 20 | 5 |
| H μm | 4 | 4 | 4 |
| Maximum | 692 | 773 | 650 |
| stress | | | |
| MPa | | | |

Namely, as in example of the above Table 1, by conventional surface roughnesses Rₐ and R_{y} for defining the texture, the shape of the particles of the CVD-SiC coating film or the size of each particle cannot be expressed, and the texture of the

SiC-CVD film cannot be accurately expressed. For this reason, it has not been possible to understand easiness of peeling or fracture of the deposit film quantitatively. Further, there has also been a problem that a contact type surface roughness meter cannot capture a surface roughness formed by extremely small particles.

The shape of each particle can be known from a scanning electron microscope (SEM). Such an SEM can provide a quantitative size information with respect to X-Y two-dimensional plane, but an SEM does not provide a quantitative size information in Z direction. Accordingly, by SEM observation, it is not possible to obtain a three-dimensional information of the texture in the same manner as the case of surface roughness.

In order to solve the above problems, the present inventors have observed a CVD-SiC coating film by a laser microscope which can obtain a three-dimensional quantitative size information, and they have discovered from the observation result that the texture can be expressed by I1 and I2 being values obtained by integrating with respect to ω a Fourier amplitude spectrum of a cross-sectional profile, that is a cross-sectional profile of the CVD-SiC coating film obtained by calculation from the observation result applied with a Fourier series.

The values of I1 and I2 change according to the number and the height of peaks present in respective ranges of the frequency ω, and the values become large as the number of peaks present in the range of frequency ω is large and as the height of each peak is high. The Fourier amplitude spectrum of a cross-sectional profile of an actual CVD-SiC coating film has, as shown in example of FIG. 4, a continuous spectrum-like shape formed by overlapping peaks, and accordingly, the values of I1 and I2 deeply depend on the height of the peaks. Further, according to the research of the inventors, particles present in the region of 0.01≦ω≦0.02 are mainly dome-shaped particles, and particles present in the region of 0.05≦ω≦0.2 are mainly particles having a pyramid shape or a column shape.

As described above, as the number of peaks present in the range of specific frequency ω is large, or the height of peaks are high, the values of I1 and I2 become large. Accordingly, as the value of I1 is large, the number of dome-shaped particles having a large height is large, and as the value of I2 is large, the number of particles having a pyramid or a column shape having a large height is large. Thus, by evaluating the values of I1 and I2, it is possible to know the outline of the texture of a CVD-SiC coating film.

According to the research of the inventors, using I1=0.7 and I2=1.5 as rough boarders, in a region where I1 is larger than 0.7 and I2 is smaller than 1.5, the texture is mainly constituted by dome-shaped particles and few clear pyramid-shaped or column-shaped particles are observed in this region.

On the other hand, in a region wherein I1 is smaller than 0.7 and I2 is larger than 1.5, the texture is mainly constituted by pyramid-shaped or column-shaped particles.

Further, in a region where I1 is larger than 0.7 and I2 is larger than 1.5, the texture is one wherein dome-shaped particles and pyramid-shaped or column-shaped particles are mixed.

Further, in a region where I1 is smaller than 0.7 and I2 is smaller than 1.5, both of dome-shaped particles and pyramid-shaped particles do not grow large, and a smooth texture is formed as a whole.

With respect to these features, a relationship between values of I1, I2 and the texture is specifically described by using FIGS. 1 to 3. The values of I1 and I2 in FIGS. 1 to 3 are FIG. 1 (I1-0.372, I2=1.175), FIG. 2 (I1=0.444, I2=1.698) and FIG. 3 (I1=0.411, I2=0.379), respectively.

From FIGS. 1(a) to 1(c), it is understandable that since the value of I1 is larger than 0.7 and I2 is smaller than 1.5, the texture is one mainly constituted by dome-shaped particles according to Examples of FIG. 1(a) image photograph, FIG. 1(b) three-dimensional image and FIG. 1(c) cross-sectional profile by laser microscope observation. In FIGS. 2(a) to 2(c), it is understandable that since I1 is smaller than 0.7 and I2 is larger than 1.5, the texture is mainly constituted by pyramid-shaped or column-shaped texture. Further, in FIGS. 3(a) to 3(c), it is understandable that since I1 is smaller than 0.7 and the value of I2 is smaller than 1.5, the texture is flat smooth shape.

The present inventors formed CVD-SiC coating films having various textures on SiC substrates, and observed the texture of their surface portions by a laser microscope. Further, they deposited a silicon nitride film to be used for LPCVD step in an actual semiconductor manufacturing on each of the CVD-SiC coating film by a LPCVD method, and observed the state of generation of cracks in the CVD-SiC coating film and peeling of the CVD-SiC coating film. By these observations, they attempted to clarify the relation between the cracks, the peelings and the texture of CVD-SiC coating film.

The texture of the CVD-SiC coating film in the present invention was observed by using a red laser microscope, a cross-sectional profile was calculated from the observation data, and the profile was converted into Fourier amplitude spectrum using the observation length as the time axis.

As the method for converting into a Fourier amplitude spectrum, a cross-sectional profile of a CVD-SiC coating film observed by a red laser microscope with a magnification of 500× with an observation length of 282 μm at 1,024 point with a constant pitch, was converted into a Fourier amplitude spectrum by using the observation length as the time axis. An integral value of the Fourier amplitude spectrum in a frequency ω range of from 0.01 to 0.02 was designated as I1, and that in a frequency ω range of from 0.05 to 0.2 was designated as I2. Further, an integral value within a frequency ω range of from 0.4 to 0.8 is designated as I3.

As a result, it was understood that a texture of CVD-SiC having a I1 of at least 0.9 or a texture of a CVD-SiC coating film having a I1 of at most 0.9 and a I2 of at least 1.6, was effective to improve adhesiveness of deposit film or to significantly suppress generation of cracks of the deposit film. In order to increase these effects, it is preferred that I1 is at most 0.9 and I2 is at least 1.6. It is more preferred that I1 is at most 0.4 and I2 is at least 1.6. It is particularly preferred that I2 is at least 3 and I3/I1 is at most 0.6.

The values of I1, I2 and I3 change according to observation magnification of the laser microscope, and thresholds corresponding to the respective magnifications may be set, but by observation with low magnification, an accurate profile may not be measured due to noise generated by the effect of reflection of laser light.

Further, when observation is made with high magnification, observation length becomes short and only a specific particle can be observed and the entire texture may not be obtained. For example, in a texture constituted by sufficiently grown large dome-shaped particles, the diameter of each particle becomes as large as tens of μm, and if the particle is observed with a magnification of at least 1,000×, observation of only one particle is possible. Although depending on the performance of microscope to be used, observation at 400 to 60033 is appropriate for the above reason, and the magnification is more preferably 500×.

Further, measurement of cross-sectional profile is carried out at least 5 times for each observation image, and I1, I2 and I3 calculated from these cross-sectional profiles are averaged to obtain average I1, average I2 and average I3 showing the texture of the sample. The cross-sectional profile is preferably measured at least 5 times with a pitch of at least 10 μm and at most 50 μm, and more preferably measured at least 5 times with a pitch of from 20 to 30 μm.

In the present invention, it becomes possible to reduce the frequency of cleaning steps by controlling the texture of the CVD-SiC coating film of a CVD-SiC-covered SiC heat treatment member to be within the above range, even if a deposit film is deposited to have a large thickness in a LPCVD step in a semiconductor manufacturing process.

### EXAMPLES

Now, the present invention will be described in more detail with reference to Examples, but the present invention is not limited to these Examples.

### Example 1

On SiC substrates, respective CVD-SiC coating films having a thickness of about 60 μm and having various textures were deposited by controlling the film-deposition conditions, to produce substrates, and a silicon nitride film having a thickness of about 6 μm was deposited on each substrate by a LPCVD method. The thickness of the silicon nitride film by each deposition was set to be about 1.5 μm, and after the coating, a forced cooling was carried out with a wind velocity of about 1 m/sec. These operations were repeated four times to form a silicon nitride film having a total thickness of 6 μm. The silicon nitride film was observed by an optical microscope to measure the number of cracks present in the silicon nitride film.

The texture of the CVD-SiC coating film on the SiC substrate was observed by employing a red laser microscope (manufactured by Keyence Corporation, model VK8710). With a magnification of 500× with an observation length of 282 μm, the texture was measured at 1,024 points at a constant pitch to obtain a cross-sectional profile of the CVD-SiC coating film, and the cross-sectional profile was converted into a Fourier amplitude spectrum using the observation length as the time axis. An integral value of the Fourier amplitude spectrum in a frequency ω range of from 0.01 to 0.02 was designated as I1, and the integral value in a frequency ω range of from 0.05 to 0.2 was designated as I2. The cross-sectional profile was measured at 8 points so that the interval between the cross sections became 27.6 μm. I1s and I2s obtained from respective cross-sectional profiles were averaged to obtain average I1 and average I2 of the CVD-SiC coating film (hereinafter, average I1 and average I2 are simply referred to as I1 and I2), respectively.

As a result, as shown in FIG. 5, the number of cracks generated in a silicon nitride film coated on a substrate having a CVD-SiC coating film having a texture that I1 was at most 0.9 and I2 was at least 1.6 or I1 was at least 0.9, was remarkably less than the number of cracks generated in a silicon nitride film coated on other substrates.

FIG. 5 is a graph wherein the crack density in the silicon nitride film according to the above observation result is represented by the area of circle, and the texture of CVD-SiC coating film in each substrate is plotted in a coordinate wherein the horizontal axis represents I1 and the vertical axis represents I2. The area of each circle in the graph represents relative number of cracks generated per a unit area in the silicon nitride film deposited on the CVD-SiC coating film located in the above coordinate. Namely, a large area of a circle indicates that cracks tends to be generated at the values of I1 and I2. In an area where I1 is less than 0.9 and I2 is less than 1.6, many circles having large areas are present, which indicates that cracks tends to be generated in the silicon nitride film deposited on the substrate having the CVD-SiC coating film.

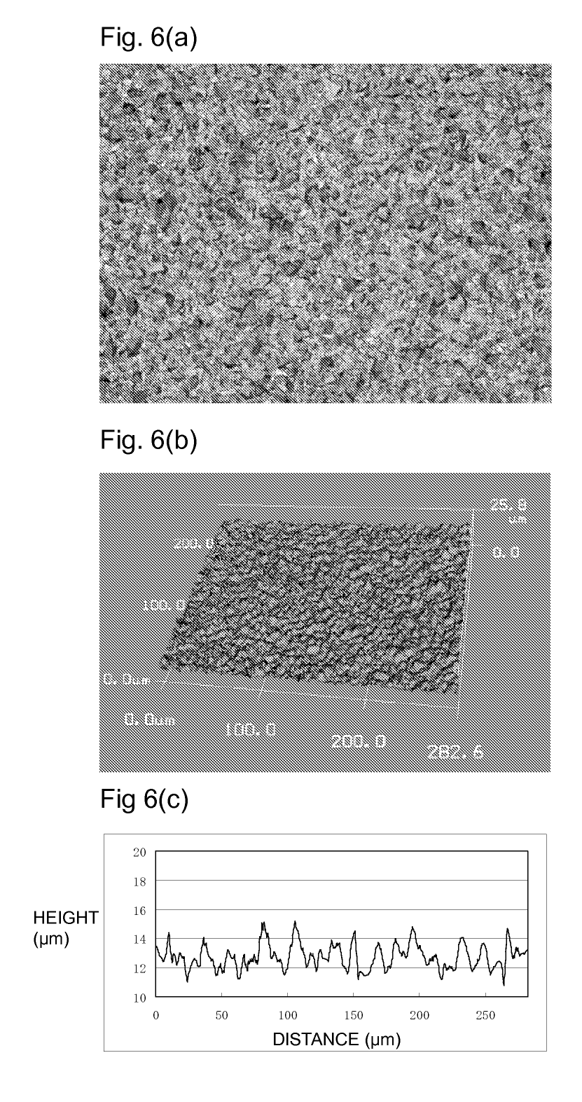

FIG. 6 shows a texture of CVD-SiC coating film whereby the number of cracks shown in FIG. 5 is the minimum, that is whereby the radius of the circle is the smallest. Values of I1 and I2 in FIG. 5 are I1=0.227 and I2=2.026, respectively.

### Example 2

On SiC substrates, respective CVD-SiC coating films having a thickness of about 60 μm and having textures that I1 was at least 0.9 or I1 was at most 0.9 and I2 was at least 1.6, were deposited by controlling the film-deposition conditions to produce substrates, and on each substrate, a silicon nitride film having a thickness of about 6 μm was deposited by a LPCVD method. The thickness of the silicon nitride film by each deposition was set to be about 1.5 μm, and after the coating, a forced cooling with a wind velocity of about 1 m/sec was carried out, and these operations were repeated four times to form a silicon nitride film having a total thickness of about 6 μm. The silicon nitride film was observed by an optical microscope to measure the number of cracks present in the silicon nitride film so as to classify them into cracks due to peeling of the silicon nitride film and cracks due to brittle fracture by internal stress.

The texture of the CVD-SiC coating film on the SiC substrate was observed by employing a red laser microscope (manufactured by Keyence Corporation, model VK8710). The texture was observed with a magnification of 500× with an observation length of 282 μm, at 1,024 points with a constant pitch, to obtain a cross-sectional profile of the CVD-SiC coating film, and the cross-sectional profile was converted into a Fourier amplitude spectrum using the observation length as the time axis. An integral value of the Fourier amplitude spectrum in a frequency ω range of from 0.01 to 0.02 was designated as I1, the integral value in a frequency ω range of from 0.05 to 0.2 was designated as I2, and an integral value in a frequency ω range of 0.04≦ω≦0.8 was designated as I3. The cross-sectional profile was measured at 8 points so that the interval between cross sections became 27.6 μm. I1 s, I2s and I3s obtained from the cross-sectional profiles were each averaged to obtain an average I1, an average I2 and a average I3 of the CVD-SiC coating film (hereinafter, average I1, average I2 and average I3 are simply referred to as I1, I2 and I3, respectively).

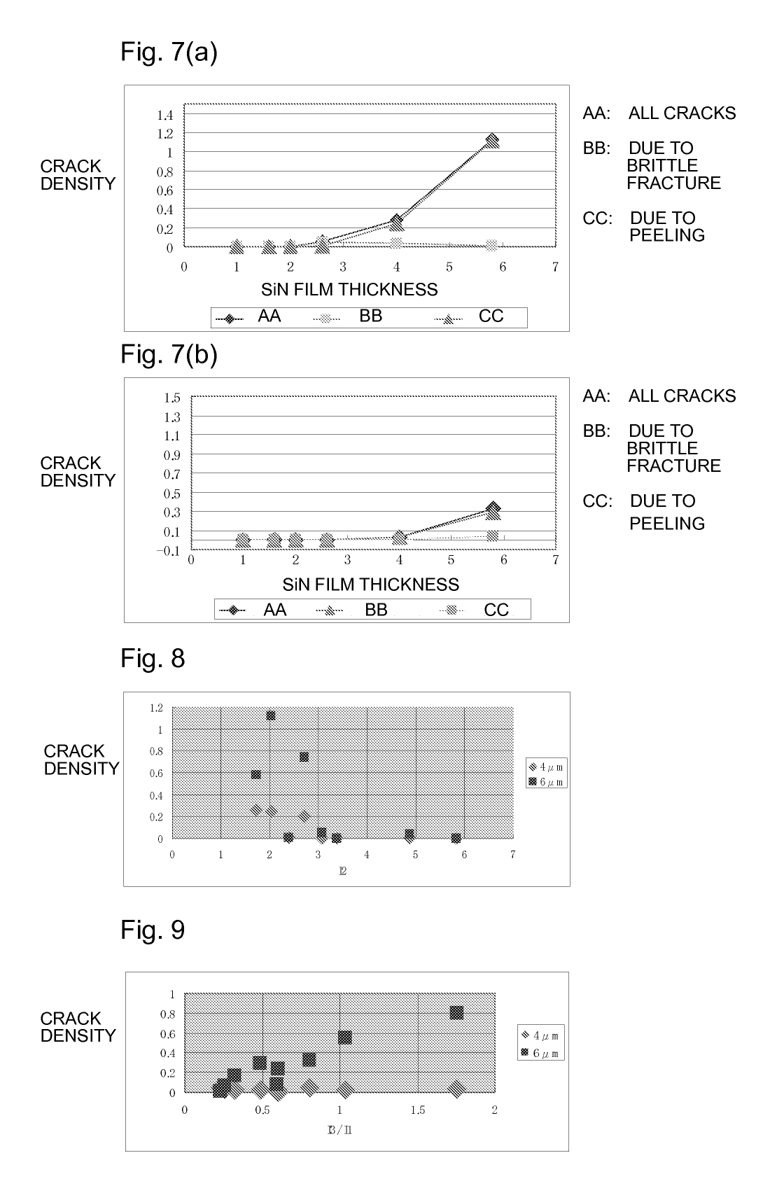

FIG. 7(a) and FIG. 7(b) are each an example of graph wherein the horizontal axis represents the thickness of silicon nitride film and the vertical axis represents the number of cracks due to brittle fracture by internal stress and the total number per a unit area, according to the above observation result when the silicon nitride film has a thickness of about 1 μm to 6 μm and is coated on samples having different I1, I2 and I3 values. The graphs indicate that as the thickness of the silicon nitride film increases, the number of cracks increases, and as the thickness of the silicon nitride film increases, the coating film tends to be fractured.

Here, in FIG. 7(a), most cracks of the silicon nitride film were cracks due to peeling of the silicon nitride film, while in FIG. 7(b), although the number of cracks was small, most cracks were cracks due to brittle fracture by internal stress. Thus, the figures indicate that the fracture mechanism of the silicon nitride film differs by the difference of texture, and that when peeling of the silicon nitride film occurs, fracture of the film quickly develops.

FIG. 8 is a graph showing I2 in the horizontal axis and the number of cracks due to peeling of silicon nitride film per a unit area in the vertical axis with respect to all samples coated with silicon nitride films having a thickness of about 4 μm or about 6 μm. FIG. 8 indicates that the number of cracks decreases as I2 increases, and few cracks due to peeling are present and substantially no peeling occurs particularly in a region where I2 exceeds 3.

FIG. 9 is a graph showing I3/I1 in the horizontal axis and the number of cracks due to brittle fracture of silicon nitride film per a unit area with respect to all samples coated with silicon nitride films having a thickness of about 4 μm or about 6 μm in the vertical axis. The graph indicates that many cracks are generated when the thickness of silicon nitride film exceeds 4 μm, but the number of cracks decreases as I3/I1 decreases, and, few cracks are present and substantially no crack due to brittle fracture is generated particularly in a region where I3/I1 is smaller than 0.6.

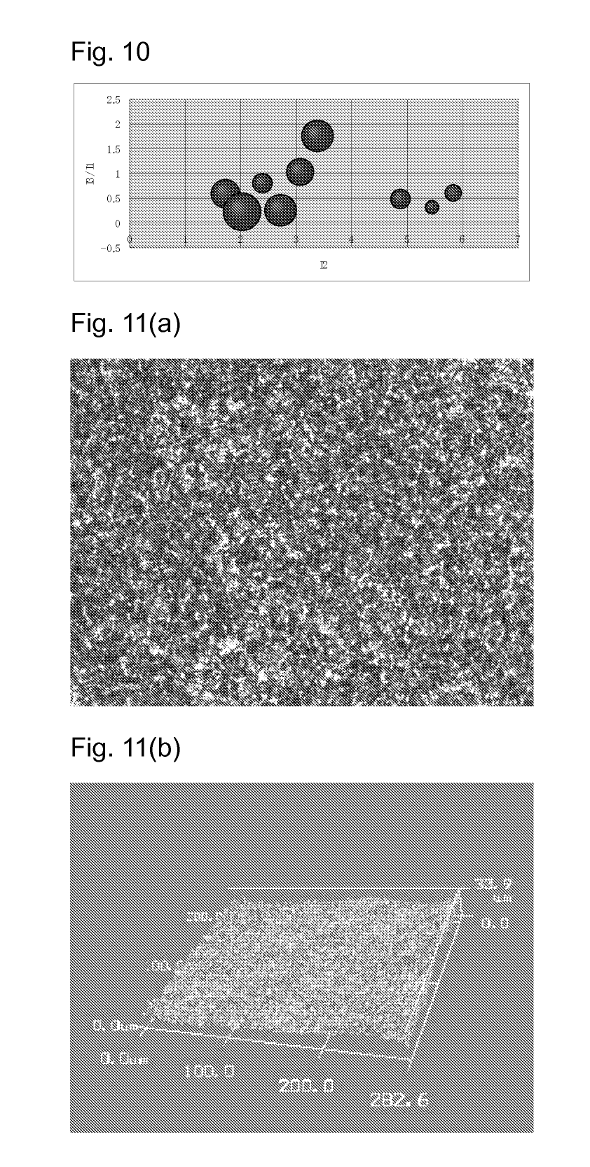

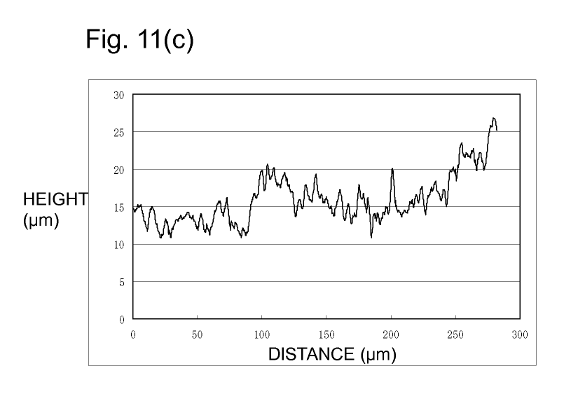

FIG. 10 is a graph showing the crack density in the silicon nitride film according to the above observation result by the area of circle and the CVD-SiC coating film texture of each substrate by the position in a coordinate wherein the horizontal axis represents I2 and the vertical axis represents I3/I1. The area of each circle in the graph relatively represents the total number of cracks due to peeling of silicon nitride film and cracks due to brittle fracture per a unit area generated in a silicon nitride film deposited on a CVD-SiC coating film, located in the above coordinate. Namely, as the area of the circle is large, cracks tends to be generated at the values of I2 and I3/I1. In the region where I2 is at least 3 and I3/I1 is at most 0.4, the area of each circle is smaller than those of other regions, which indicates that generation of cracks is suppressed in the nitride film deposited on the substrate having the CVD-SiC coating film in the region. FIG. 11 shows the texture of the CVD-SiC coating film whereby the number of cracks is the minimum in the samples of FIG. 10, that is, whereby the radius of each circle is the smallest. The values of I2 and I3/I1 in FIG. 10 were I2=5.452 and I3/I1=0.322, respectively.

### INDUSTRIAL APPLICABILITY

The present invention is applicable to a semiconductor heat treatment member having a SiC film deposited in LPCVD step in a semiconductor manufacturing process.

This application is a continuation of PCT Application No. PCT/JP2010/056712, filed Apr, 14, 2010, which is based upon and claims the benefit of priority from Japanese Patent Application No. 2009-107932 filed on Apr. 27, 2009. The contents of those applications are incorporated herein by reference in its entirety.

What is claimed is:

1. A semiconductor heat treatment member having a CVD-SiC film, wherein an average I1 and an average I2 of the CVD-SiC film obtained according to the following steps (1) to (6) satisfy the following (A) or (B):
(A) the average I1 is at most 0.9 and the average I2 is at least 1.6;
(B) the average I1 is at least 0.9;
(1) a surface of the CVD-SiC film is observed by a laser microscope with a magnification of from 400 to 600×;
(2) from the observation of the CVD-SiC film by the laser microscope, cross-sectional profile is measured at each of at least 5 points at intervals of at least 10 μm and 50 μm in terms of the intervals between the cross sections;
(3) Fourier conversion of each of the measured cross-sectional profile is carried out;
(4) a Fourier amplitude spectrum is calculated from the Fourier conversion data;
(5) definite integration of the Fourier amplitude spectrum is carried out with respect to a frequency (ω) in an integration range of 0.01≦ω≦0.02 for I1 and an integration range of 0.05≦ω≦0.2 for I2 to obtain I1 and I2; and
(6) I1s and I2s obtained from the cross sectional profiles measured at at least 5 points along X direction are each averaged to obtain an average I1 and an average I2 of the CVD-SiC film.

2. The semiconductor heat treatment member according to claim 1, wherein the average I1 is at most 0.4 and the average I2 is at least 1.6.

3. The semiconductor heat treatment member according to claim 1, wherein the average I2 is at least 3 and a ratio between an average I3 and the average I1 (average I3/average I1) is at most 0.6 where the average I3 is obtained by averaging I3s obtained by carrying out a definite integration of the respective Fourier amplitude spectrums obtained from cross-sectional profiles measured at at least 5 points at intervals of at least 10 μm and at most 50 μm, in an integration range of 0.4≦ω≦0.8.

4. An evaluation method of a SiC film for a semiconductor heat treated member having a CVD-SiC film, which comprises expressing the surface state of the CVD-SiC film by using an average I1 and an average I2 obtained according to the following steps (1) to (6):
(1) a surface of the CVD-SiC film is observed by a laser microscope with a magnification of from 400 to 600×;
(2) from the observation of the CVD-SiC film by the laser microscope, a cross-sectional profile is measured at each of at least 5 points at intervals of at least 10 μm and 50 μm in terms of the intervals between the cross sections;
(3) Fourier conversion of each of the measured cross-sectional profile is carried out;
(4) a Fourier amplitude spectrum is calculated from the Fourier conversion data;
(5) definite integration of the Fourier amplitude spectrum is carried out with respect to a frequency (ω) in an integration range of 0.01≦ω≦0.02 for I1 and an integration range of 0.05≦ω≦0.2 for I2 to obtain I1 and I2; and
(6) I1s and I2s obtained from the cross sectional profiles measured at at least 5 points along X direction are each averaged to obtain an average I1 and an average I2 of the CVD-SiC film.

5. An evaluation method of SiC film for a semiconductor heat treatment member having a CVD-SiC film, which comprises expressing the surface state of the CVD-SiC film by employing the average I1, the average I2 and the average I3 obtained according to the following steps (1) to (8):
(1) a surface of the CVD-SiC film is observed by a laser microscope with a magnification of from 400 to 600×;
(2) from the observation of the CVD-SiC film by the laser microscope, a cross-sectional profile is measured at each of at least 5 points at intervals of at least 10 μm and 50 μm in terms of the intervals between the cross sections;
(3) Fourier conversion of each of the measured cross-sectional profile is carried out;
(4) a Fourier amplitude spectrum is calculated from the Fourier conversion data;
(5) definite integrations of the Fourier amplitude spectrum are carried out with respect to a frequency (ω) in an integration range of 0.01≦ω≦0.02 for I1 and an integration range of 0.05≦ω≦0.2 for I2 to obtain I1 and I2;
(6) I1s and I2s obtained from the cross sectional profiles measured at at least 5 points along X direction are each averaged to obtain an average I1 and an average I2 of the CVD-SiC film;
(7) a definite integration of each of the Fourier amplitude spectrums is carried out with respect to the frequency (ω) in an integration range of 0.4≦ω≦0.8 for I3 to obtain I3; and
(8) I3s obtained from cross-sectional profiles measured at at least 5 points in X direction are averaged to obtain an average I3 of the CVD-SiC film.
